(19) United States
(12) Patent Application Publication
(10) Pub. No.: US 2013/0021325 A1
(43) Pub. Date: Jan. 24, 2013

(54) THREE-DIMENSIONAL IMAGE DISPLAY DEVICE AND A DRIVING METHOD THEREOF

(71) Applicants: Bo-Ram KIM, Seoul (KR); Myoung-Chul KIM, Suwon-si (KR); Seung Hwan MOON, Asan-si (KR); Byoung Jun LEE, Yongin-si (KR); Yun-Jae KIM, Seoul (KR); Nam-Hee GOO, Asan-si (KR); Jong-Yoon LEE, Ansan-si (KR)

(72) Inventors: Bo-Ram KIM, Seoul (KR); Myoung-Chul KIM, Suwon-si (KR); Seung Hwan MOON, Asan-si (KR); Byoung Jun LEE, Yongin-si (KR); Yun-Jae KIM, Seoul (KR); Nam-Hee GOO, Asan-si (KR); Jong-Yoon LEE, Ansan-si (KR)

(21) Appl. No.: 13/299,636

(22) Filed: Nov. 18, 2011

(30) Foreign Application Priority Data
Jul. 22, 2011 (KR) 10-2011-0073280

(51) Int. Cl. G06T 15/00

(52) U.S. Cl. 345/419

(57) ABSTRACT

A three-dimensional (3D) image display device including a display panel assembly including a display panel displaying an image and a timing controller, an integration controller transmitting an input image signal to the timing controller, a shutter member including a left eye shutter and a right eye shutter, a shutter timing determining unit receiving a shutter member control source signal from the integration controller or an outside source to generate shutter timing information, and a shutter timing controller receiving the shutter timing information to generate a shutter member control signal and transmitting the shutter member control signal to the shutter member, wherein an open time or a close time of the left eye shutter or the right eye shutter for a frame is based on the shutter timing information.

### CROSS-REFERENCE TO RELATED APPLICATION

This application claims priority under 35 U.S.C. §119 to Korean Patent Application No. 10-2011-0073280 filed in the Korean Intellectual Property Office on Jul. 22, 2011, the disclosure of which is incorporated by reference herein in its entirety.

### BACKGROUND

1. Technical Field

The present invention relates to a three-dimensional (3D) image display device and a driving method thereof, and more particularly, to a 3D image display device including shutter glasses and a driving method thereof.

2. Discussion of the Related Art

In general, a 3D image display technique allows a viewer to feel the depth (e.g., a 3D effect) of an object by using binocular parallax.

Binocular parallax may exist due to the eyes of a person being spaced apart from each other by a predetermined distance, and thus, a two-dimensional (2D) image seen in a left eye is different from that seen in a right eye. Thus, the person's brain blends the two different 2D images together to generate a 3D image that is a perspective and realistic representation of the object being viewed.

Techniques for displaying 3D images, which use the binocular parallax, may include a stereoscopic method and an autostereoscopic method. The stereoscopic method uses glasses such as shutter glasses, polarized glasses, or the like, and the autostereoscopic method does not use glasses, but instead arranges a lenticular lens and a parallax barrier or the like in a display device.

In the stereoscopic shutter glasses method, an image to be seen in the left eye and an image to be seen in the right eye image are separately and continuously outputted from a 3D image display device to a pair of shutter glasses and a left eye shutter and a right eye shutter of the shutter glasses are selectively opened and closed, thereby displaying a 3D image.

However, in the stereoscopic shutter glasses method, the open and close pattern of the shutters may cause light surrounding a display panel of the 3D image display device to impact the quality of the 3D image. Accordingly, there is a need to improve the quality of a 3D image seen through shutter glasses.

### SUMMARY

The present invention provides a realistic three-dimensional (3D) image by controlling the luminance of surroundings that are seen through a shutter member of a 3D image display device.

A 3D image display device according to an exemplary embodiment of the present invention includes: a display panel assembly including a display panel displaying an image and a timing controller; an integration controller transmitting an input image signal to the timing controller; a shutter member including a left eye shutter and a right eye shutter; a shutter timing determining unit receiving a shutter member control source signal from the integration controller or an outside source to generate shutter timing information; and a shutter timing controller receiving the shutter timing information to generate a shutter member control signal and transmitting the shutter member control signal to the shutter member, wherein an open time or a close time of the left eye shutter or the right eye shutter for a frame is based on the shutter timing information.

The open time of the left eye shutter or the right eye shutter for the frame increases as a value of the shutter timing information increases.

The display panel assembly further includes a data driver transmitting a data voltage to a data line of the display panel.

The data voltage may include a left eye data voltage and a right eye data voltage, a vertical blank period may be positioned between an input period of the left eye data voltage and an input period of the right eye data voltage, and at least a portion of the open time of the left eye shutter or the right eye shutter for the frame may be positioned in the vertical blank period.

Only one of the left eye shutter and the right eye shutter may be opened in the vertical blank period.

The 3D image display device may further include a backlight unit providing light to the display panel, wherein the backlight unit may provide the light after a first time has elapsed until a second time elapses, wherein the first time is measured from an end point of the input period of the data voltage prior to the vertical blank period, and the second time is measured from a starting point of the input period of the data voltage after the vertical blank period.

At least one of the first time and the second time may be 0.

The shutter member control source signal may include the input image signal, and the shutter timing determining unit may include an image luminance summing unit receiving the input image signal from the integration controller or the timing controller and summing grays for a plurality of pixels from the input image signal to calculate a sum value.

The shutter timing determining unit may include a lookup table storing image luminance steps having corresponding sum values and corresponding shutter timing information values, and a step pointing unit selecting an image luminance step and the shutter timing information corresponding to the sum value from the lookup table.

The shutter timing determining unit may include a shutter timing calculation unit calculating the shutter timing information based on the sum value.

The shutter timing calculation unit may calculate the shutter timing information according to a linear function equation.

The display panel assembly may further include a data driver transmitting a data voltage to a data line of the display panel, the data voltage may include a left eye data voltage and a right eye data voltage, a vertical blank period may be positioned between an input period of the left eye data voltage and an input period of the right eye data voltage, and at least a portion of the open time of the left eye shutter or the right eye shutter for the frame may be positioned in the vertical blank period.

When the sum value is the highest value in the lookup table, the open time of the right eye shutter or the left eye shutter for the frame may start when a third time has elapsed from a start point of the input period of the data voltage prior to the vertical blank period, and may end a fourth time prior to an end point of the input period of the data voltage after the vertical blank period.

At least one of the third time and the fourth time may be 0.

The shutter member control source signal may include a surrounding luminance control signal, and the shutter timing determining unit may generate the shutter timing information according to the surrounding luminance control signal input from the integration controller.

The 3D image display device may further include: an illumination sensor sensing surrounding luminance to generate a detection signal; and an analog-to-digital (A/D) conversion unit A/D-converting the detection signal to generate surrounding luminance information, wherein the shutter member control source signal may include the surrounding luminance information, and the shutter timing determining unit may receive the surrounding luminance information to generate the shutter timing information.

A driving method of a 3D image display device including a display panel assembly including a display panel and a timing controller, an integration controller transmitting an input image signal to the timing controller, a shutter member including a left eye shutter and a right eye shutter, and a shutter timing determining unit according to an exemplary embodiment of the present invention includes: receiving, at the shutter timing determining unit, a shutter member control source signal from the integration controller or an outside source to generate shutter timing information; and controlling, with a shutter timing controller of the 3D image display device, an open time or a close time of the left eye shutter or the right eye shutter for a frame according to the shutter timing information.

The open time of the left eye shutter or the right eye shutter for the frame is increased as a value of the shutter timing information is increased.

The shutter member control source signal includes the input image signal from the integration controller or the timing controller, and the method may further comprise: inputting the input image signal to the shutter timing determining unit; and summing, at the shutter timing determining unit, grays for a plurality of pixels from the input image signal to calculate a sum value.

The shutter member control source signal includes a surrounding luminance control signal, and the method may further comprise inputting the surrounding luminance control signal to the shutter timing determining unit.

The method may further include: sensing, with an illumination sensor of the 3D image display device, a surrounding luminance to generate a detection signal; using an A/D converter of the 3D image display device to A/D-convert the detection signal to generate surrounding luminance information; and inputting, from the A/D converter, the surrounding luminance information as the shutter member control source signal to the shutter timing determining unit.

A 3D image display device according to an exemplary embodiment of the present invention includes: a display panel displaying an image; a shutter member including a first shutter and a second shutter; and a shutter timing determining unit generating shutter timing information based on a luminance of an area surrounding the image, wherein an open time of the first or second shutter is controlled in accordance with the shutter timing information.

### BRIEF DESCRIPTION OF THE DRAWINGS

FIG. 1 is a block diagram of a three-dimensional (3D) image display device according to an exemplary embodiment of the present invention.

FIG. 2 is a diagram of an operation of a 3D image display device according to an exemplary embodiment of the present invention.

FIGS. 3 and 4 are block diagrams of controllers for controlling shutter members of a 3D image display device according to exemplary embodiments of the present invention.

FIG. 5 is a lookup table illustrating how to determine an open and close timing of a shutter member of a 3D image display device according to an exemplary embodiment of the present invention.

FIG. 6 is a block diagram of a controller for controlling a shutter member of a 3D image display device according to an exemplary embodiment of the present invention.

FIGS. 7 to 10 are waveform diagrams of a driving method of a 3D image display device according to an exemplary embodiment of the present invention.

FIGS. 11 and 12 are examples of an actual image and its surrounding shape seen through a shutter member of a 3D image display device according to an exemplary embodiment of the present invention.

FIGS. 13 and 14 are block diagrams of controllers for controlling shutter members of a 3D image display device according to exemplary embodiments of the present invention.

### DETAILED DESCRIPTION OF THE EMBODIMENTS

Exemplary embodiments of the present invention will be described more fully hereinafter with reference to the accompanying drawings. However, the present invention may be embodied in various different ways and should not be construed as limited to the exemplary embodiments described herein.

In the drawings, the thickness of layers, films, panels, regions, etc., may be exaggerated for clarity. Like reference numerals may designate like elements throughout the specification and drawings.

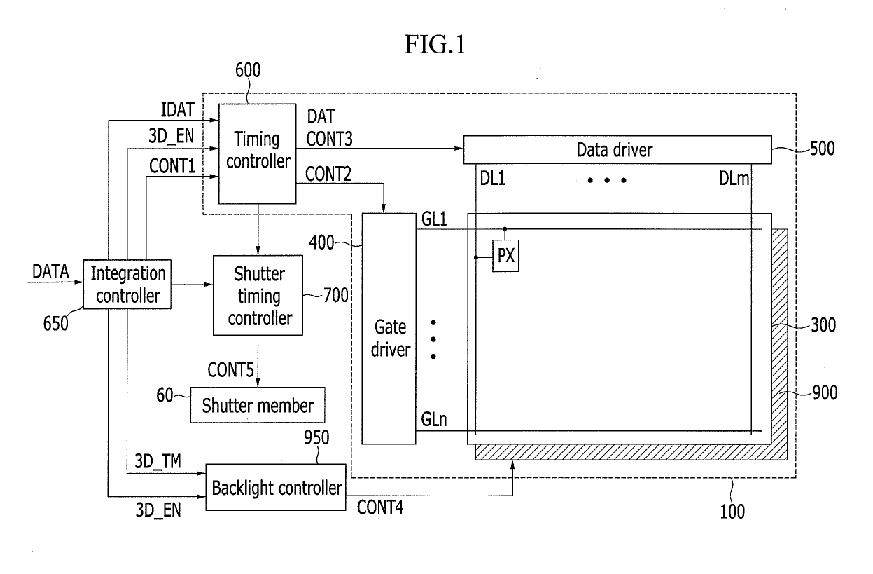

First, a three-dimensional (3D) image display device according to an exemplary embodiment of the present invention will be described with reference to FIGS. 1 to 3.

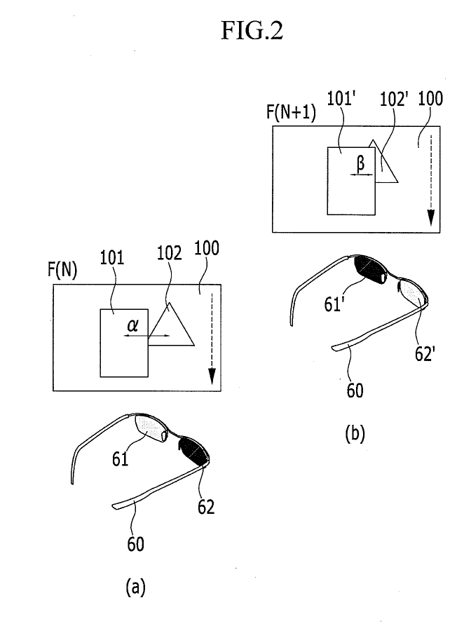

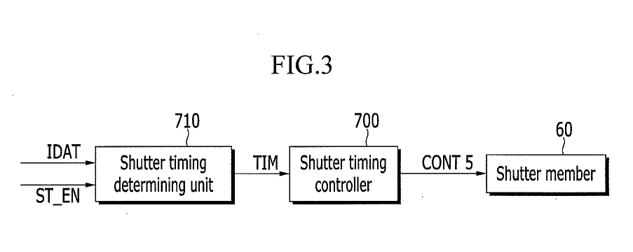

FIG. 1 is a block diagram of a 3D image display device according to an exemplary embodiment of the present invention, FIG. 2 is a diagram of an operation of a 3D image display device according to an exemplary embodiment of the present invention, and FIG. 3 is a block diagram of a controller for controlling shutter members of a 3D image display device according to an exemplary embodiment of the present invention.

Referring to FIGS. 1 and 3, a 3D image display device according to an exemplary embodiment of the present invention includes an integration controller 650, a display panel assembly 100 for displaying images, a backlight controller 950, a shutter member 60, a shutter timing controller 700, and a shutter timing determining unit 710.

The integration controller 650 according to an exemplary embodiment of the present invention receives image information DATA from the outside to generate an input image signal IDAT, a 3D enable signal 3D_EN, a 3D timing signal 3D_TM, and an input control signal CONT1, where the input control signal CONT1 controls the display of the input image signal IDAT. The integration controller 650 may transmit the input image signal IDAT, the 3D enable signal 3D_EN, and the input control signal CONT1 to a timing controller 600 of the display panel assembly 100, and the 3D enable signal 3D_EN and the 3D timing signal 3D_TM to the backlight controller 950. The input image signal IDAT contains luminance information and the luminance has a predetermined number of grays, such as 1024=2¹⁰, 256=2⁸, or 64=2⁶. The 3D enable signal 3D_EN instructs the display panel assembly 100 to enter into a 3D mode, and the 3D timing signal 3D_TM may include timing information of the 3D mode. The input control signal CONT1 may include a vertical synchronization signal Vsync, a horizontal synchronizing signal Hsync, a main clock signal MCLK, a data enable signal DE, etc.

The display panel assembly 100 may be one among several display devices including a plasma display panel (PDP), a liquid crystal display (LCD), and an organic light emitting display (OLED) device. However, the present invention is not limited thereto, since all display devices may be used as the display panel assembly 100.

The display panel assembly 100 according to an exemplary embodiment of the present invention includes a display panel 300 for displaying images, a gate driver 400 and a data driver 500 connected thereto, the timing controller 600 for controlling the gate driver 400 and the data driver 500, and a backlight unit 900 for supplying light to the display panel 300.

In an equivalent circuit, the display panel 300 includes a plurality of display signal lines, and a plurality of pixels PX that are correspondingly connected to the display signal lines and are substantially arranged in a matrix form. The display signal lines include a plurality of gate lines GL1 to GLn that transmit gate signals (also referred to as “scanning signals”) and data lines DL1 to DLm that transmit data signals. Each pixel PX includes a switching element (not shown) such as a thin film transistor connected to the corresponding gate lines GL1, . . . , GLn and the corresponding data lines DL1, . . . , DLm, and a pixel electrode (not shown) connected thereto.

The timing controller 600 controls the operation of the gate driver 400 and the data driver 500. The timing controller 600 receives the input image signal IDAT, the 3D enable signal 3D_EN, and the input control signal CONT1 from the integration controller 650. The timing controller 600 processes the input image signal IDAT to be suitable for the operating conditions of the display panel 300 based on the input image signal IDAT and the input control signal CONT1, and generates a gate control signal CONT2, a data control signal CONT3 and a processed image signal DAT (also referred to as a “digital image signal DAT”) in response thereto. The timing controller 600 outputs the gate control signal CONT2 to the gate driver 400, and outputs the data control signal CONT3 and the processed image signal DAT to the data driver 500.

The data driver 500 is connected to the data lines DL1-DLm of the display panel 300, and divides a gray reference voltage transmitted from a gray voltage generator (not shown) to generate a gray voltage for all grays. On the other hand, the data driver 500 may receive a plurality of gray voltages from the outside. The data driver 500 receives the digital image signal DAT for the pixel PX of one row according to the data control signal CONT3, and selects the gray voltage corresponding to each digital image signal DAT from the gray voltages to convert the digital image signal DAT into the data voltage Vd and transmit the data voltage Vd to the corresponding data lines DL1-DLm. The data voltage Vd may include a left eye data voltage and a right eye data voltage.

The gate driver 400 is connected to the gate lines GL1-GLn, and applies the gate signal including a combination of a gate-on voltage Von and a gate-off voltage Voff to the gate lines GL1-GLn. The gate driver 400 applies the gate-on voltage Von to the gate lines GL1-GLn according to the gate control signal CONT2 from the timing controller 600 to turn on the switching element connected to the gate lines GL1-GLn. Thus, the data voltage Vd applied to the data lines DL1-DLm may be applied to the corresponding pixel PX through the turned-on switching element.

The backlight unit 900 may be positioned at the back side of the display panel 300 and includes a light source. Examples of the light source may be a fluorescent lamp such as a cold cathode fluorescent lamp (CCFL) and a light emitting diode (LED). In addition, the backlight unit 900 may further include a reflector, a light guide, and a luminance improvement film.

The display panel assembly 100 sequentially applies the gate-on voltage Von for all gate lines GL1-GLn as a unit during 1 horizontal period (also referred to as “1H”, which is equal to one cycle of the horizontal synchronizing signal Hsync and the data enable signal DE) and applies the data voltage Vd to all pixels PX, thereby displaying the images of one frame.

The backlight controller 950 receives the 3D timing signal 3D_TM and the 3D enable signal 3D_EN from the integration controller 650 to generate the backlight control signal CONT4 based thereon, and transmits the backlight control signal CONT4 to the backlight unit 900. Different from this, the backlight controller 950 may receive the backlight control signal CONT4 from the timing controller 600. The backlight unit 900 may be turned on or off during a predetermined time according to the control of the backlight control signal CONT4.

The shutter timing determining unit 710 receives a shutter timing enable signal ST_EN from the integration controller 650, thereby determining whether the 3D mode is operated. For example, when the shutter timing enable signal ST_EN has a high level, the shutter timing determining unit 710 may be operated, and when the shutter timing enable signal ST_EN has a low level, the shutter timing determining unit 710 may be not operated. Hereafter, it is assumed that the shutter timing enable signal ST_EN has the high level.

The shutter timing determining unit 710 receives a shutter member control source signal from the outside to generate a signal TIM for an open and close timing (hereinafter this signal may be referred to as “shutter timing information TIM”) of the shutter member 60, and transmits the signal TIM to the shutter timing controller 700. The signal TIM for the open and close timing of the shutter member 60 may include information for an open or close maintaining time of a left eye shutter and a right eye shutter of the shutter member 60. The shutter member control source signal, which is a basis for determining the open and close timing of the shutters of the shutter member 60, may be the input image signal IDAT provided from the integration controller 650 or the timing controller 600, an additional control signal that is synchronized with the input image signal IDAT, an external signal for controlling the open and close timing of the shutters of the shutter member 60, or information about external illumination (e.g., information about the luminance of surrounding). The shutter timing determining unit 710 may be positioned in the integration controller 650 or the display panel assembly 100 according to an exemplary embodiment of the present invention. When the shutter timing determining unit 710 is positioned in the display panel assembly 100, it may be positioned in the timing controller 600.

Referring to FIG. 3, the shutter timing determining unit 710 according to an exemplary embodiment of the present invention receives the input image signal IDAT as the shutter member control source signal from the integration controller 650 or the timing controller 600 to generate the shutter timing information TIM based thereon. The detailed structure and the operation of the shutter timing determining unit 710 will now be described.

The shutter timing controller 700 receives the shutter timing information TIM from the shutter timing determining unit 710 to generate a shutter member control signal CONT5. The shutter timing controller 700 may be positioned in the integration controller 650 or the display panel assembly 100 like the shutter timing determining unit 710. The shutter timing controller 700 may be positioned in the timing controller 600 when it is positioned in the display panel assembly 100.

The shutter member 60 receives the shutter member control signal CONT5 from the shutter timing controller 700, and opens or closes the shutters. The shutter member 60 may be synchronized with the display panel assembly 100. A user may view the image displayed by the display panel assembly 100 as a 3D image due to the opening and closing of the shutters of the shutter member 60.

The shutter member 60 according to an exemplary embodiment of the present invention may be a pair of eye-glass shaped shutter glasses including left eye shutters 61 and 61′ and right eye shutters 62 and 62′ as shown in FIG. 2. However, the shutter member 60 is not limited thereto, and it may instead be a pair of mechanical shutter glasses (e.g., goggles), a head mounted unit, or shutter glasses made of shutters using a microelectromechanical system (MEMS).

Next, how the user may recognize the 3D image through the 3D image display device and the shutter member 60 will be described with reference to FIGS. 1 and 2.

Referring to FIG. 2, the arrow direction shown in the display panel assembly 100 represents a sequence that the gate-on voltage Von is applied to a plurality of gate lines GL1-GLn extending in an approximate row direction. In other words, the gate-on voltage Von may be sequentially applied from the first gate line GL1 (e.g., the upper gate line) to the final gate line GLn (e.g., the lower gate line) of the display panel assembly 100.

The shutter member 60, which according to this exemplary embodiment of the present invention is the pair of shutter glasses, includes the left eye shutters 61 and 61′ and the right eye shutters 62 and 62′. If the display panel assembly 100 alternately displays left eye images 101 and 102 and right eye images 101′ and 102′, the right eye shutters 62 and 62′ and the left eye shutters 61 and 61′ of the shutter member 60 are synchronized with the display panel assembly 100, and thereby the right eye shutters 62 and 62′ and the left eye shutters 61 and 61′ alternately block light. The left eye shutters 61 and 61′ may be the left eye shutter 61 in an opened state or the left eye shutter 61′ in a closed state, and the right eye shutters 62 and 62′ may be the right eye shutter 62 in a closed state or the right eye shutter 62′ in an opened state. For example, during a time that the right eye shutter 62′ is in the opened state, the left eye shutter 61′ may be in the closed state, and in contrast, during a time that the left eye shutter 61 is in the opened state, the right eye shutter 62 may be in the closed state. However, the left eye shutter and the right eye shutter may be in the opened state or the closed state according to a display mode.

Referring to FIG. 2(a), when the left eye images 101 and 102 are displayed by the display panel assembly 100, the left eye shutter 61 of the shutter member 60 enters the opened state such that the left eye images 101 and 102 are transmitted to the left eye and the right eye shutter 62 of the shutter member 60 enters the closed state such that the left eye images 101 and 102 are blocked from the right eye. Referring to FIG. 2(b), if right eye images 101′ and 102′ are displayed by the display panel assembly 100, the right eye shutter 62′ of the shutter member 60 enters the opened state such that the right eye images 101′ and 102′ are transmitted to the right eye and the left eye shutter 61′ of the shutter member 60 enters the closed state such that the right eye images 101′ and 102′ are blocked from the left eye. Accordingly, the left eye image may be seen only by the left eye during a predetermined time, and then the right eye image may be seen only by the right eye during a predetermined time. Accordingly, an image having depth perception (e.g., a 3D image) may be seen due to the difference between the left eye image and the right eye image.

The image seen by the left eye during an N-th frame F(N) is an image in which a quadrangle of the left eye image 101 and a triangle of the left eye image 102 are separated by a distance α. On the other hand, the image seen by the right eye during an (N+1)-th frame F(N+1) is an image in which a quadrangle of the right eye image 101′ and a triangle of the right eye image 102′ are separated by a distance β. Here, α and β may have different values. As described above, if the distance between the images seen by the left and right eyes is different, the quadrangle may appear closer to the wearer of the shutter member 60 and the triangle may appear behind the quadrangle to the wearer of the shutter member 60, thereby giving depth to these objects. It is possible to adjust the distance (and consequently the perceived depth) between two objects spaced apart from each other by adjusting the distances α and β between the quadrangles and the triangles.

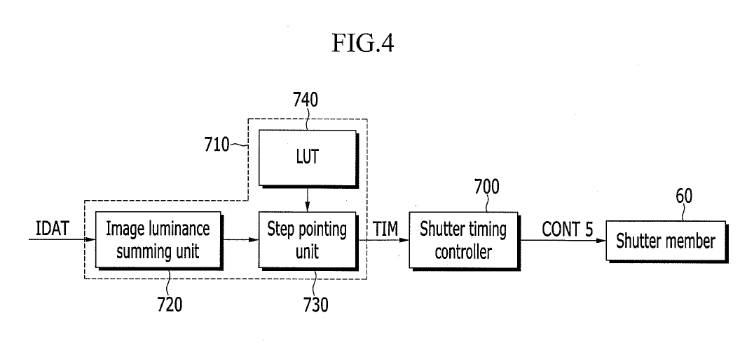

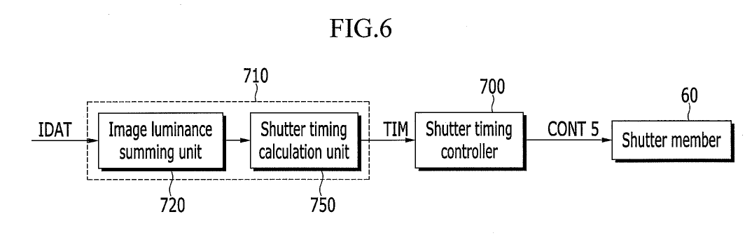

Next, structures of a shutter timing determining unit of a 3D image display device according to exemplary embodiments of the present invention will be described with reference to FIGS. 4 to 6 as well as FIGS. 1 to 3. For reference numerals in FIGS. 4 and 6 that designate like elements in FIGS. 1 and 3, the same descriptions will be omitted.

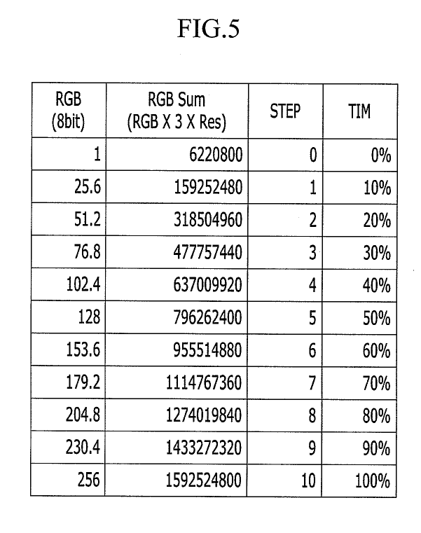

FIG. 4 is a block diagram of a controller for controlling a shutter member of a 3D image display device according to an exemplary embodiment of the present invention, FIG. 5 is a lookup table illustrating how to determine an open and close timing of a shutter member of a 3D image display device according to an exemplary embodiment of the present invention, and FIG. 6 is a block diagram of a controller for controlling a shutter member of a 3D image display device according to an exemplary embodiment of the present invention.

First, as shown FIGS. 1, 3, and 4, with particular reference to FIG. 4, a 3D image display device according to an exemplary embodiment of the present invention includes a shutter member 60, a shutter timing controller 700 for controlling the open and close timing of the shutters of the shutter member 60, and a shutter timing determining unit 710 for providing the shutter timing information TIM to the shutter timing controller 700.

The shutter timing determining unit 710 according to an exemplary embodiment of the present invention includes an image luminance summing unit 720, a step pointing unit 730, and a lookup table (LUT) 740.

The image luminance summing unit 720 receives the input image signal IDAT from the integration controller 650 or the timing controller 600 to sum the grays for a plurality of pixels PX. For example, the image luminance summing unit 720 may sum the grays for all pixels PX from the input image signal IDAT for one frame. Referring to the lookup table of FIG. 5, the pixels PX include red (R), green (G), and blue (B) pixels, the gray displayed by each pixel PX is from 0 gray to 255 gray, and when the resolution (Res) of the display panel 300 is 1920×1080, the sum of the grays of all pixels PX for one frame may be calculated like that shown in the second column (i.e., “RGB Sum”) of the lookup table of FIG. 5. Here, for convenience of calculation, 0 gray is referred to as 1 gray and 255 gray is referred to as 256 gray, and the grays of all R, G, and B pixels PX are equal to each other, however the present invention is not limited thereto.

The lookup table 740 divides the sum of the grays of all pixels PX into n steps (n is a natural number more than 2). The final step, which is the n-th step, may corresponded to a case where the gray value of all pixels PX is the highest value. Referring to the lookup table shown in FIG. 5, the sum of the grays of all pixels PX may be divided from the 0-th step to the tenth step. For example, when the gray value of all pixels PX is 25.6 gray, the sum of the grays of all pixels PX is 159,252,480, and the sum of the image luminance may be specified as the first step. When the sum of the grays of all pixels PX is more than the sum of the grays of all pixels PX corresponding to the (n-1)-th step in the lookup table 740 and is less than the sum of the grays of all pixels PX corresponding to the n-th step in the lookup table 740, it may be regarded that the sum of the grays of all pixels PX is included in the n-th step. In contrast, when the sum of the grays of all pixels PX is more than the sum of the grays of all pixels PX of the (n-1)-th step and is less than the sum of the grays of all pixels PX of the n-th step, it may be regarded that the sum of the grays of all pixels PX is included in the (n-1)-th step in the lookup table 740. For example, when the sum of the grays of all pixels PX is between 6,220,800 and 159,252,480, the sum of the image luminance may be specified as the 0th step or the first step.

The number n of the steps of the sum of the image luminance is not limited to the lookup table shown in FIG. 5 and may be infinite. When the number n is infinite, the sum of the grays of all pixels PX and the image luminance steps have a one to one correspondence such that the image luminance steps corresponding to the sum of the grays of all pixels PX may be determined as continuous values by a functional equation such as a linear function.

The step pointing unit 730 receives the sum of the grays of all pixels PX from the image luminance summing unit 720, thereby specifying or selecting the step corresponding to the sum of the grays of all pixels PX in the lookup table 740. According to the selection of the step, the step pointing unit 730 transmits the shutter timing information TIM for the shutter member 60 to the shutter timing controller 700. As shown in FIG. 5, the shutter timing information TIM may have a value of a ratio (%) of the time that the shutter member 60 is opened, and as the sum of the grays of all pixels PX is increased, the value of the shutter timing information TIM may become larger. In addition, the shutter timing information TIM may further include information such as a start point when the shutter member 60 is opened and a distribution of a period when the shutter member 60 is opened.

The shutter timing controller 700 generates the shutter member control signal CONT5 for controlling the opening and closing of the shutters of the shutter member 60 according to the shutter timing information TIM. The shutter member control signal CONT5 according to an exemplary embodiment of the present invention may control the time that the shutter of the shutter member 60 is opened according to the sum of the grays for all pixels PX of the input image signal IDAT, in other words, the sum of the luminance of the image displayed by the display panel 300.

Referring to FIG. 6, a shutter timing determining unit 710 according to an exemplary embodiment of the present invention includes an image luminance summing unit 720 and a shutter timing calculation unit 750.

The image luminance summing unit 720 and the shutter timing controller 700 according to the present exemplary embodiment may be the same as those in the exemplary embodiment shown in FIG. 4 such that a detailed description is omitted. As described above for the exemplary embodiment shown in FIG. 4, the shutter timing calculation unit 750 may calculate the shutter timing information TIM corresponding to the sum of the grays of all pixels PX by using the functional equation when the number of steps of the lookup table 740 is infinite. For example, the shutter timing calculation unit 750 may calculate the shutter timing information TIM corresponding to the sum of the grays of all pixels PX according to a functional equation such as a linear function equation. Accordingly, as the sum of the grays of all pixels PX becomes large, the value of the shutter timing information TIM may become larger.

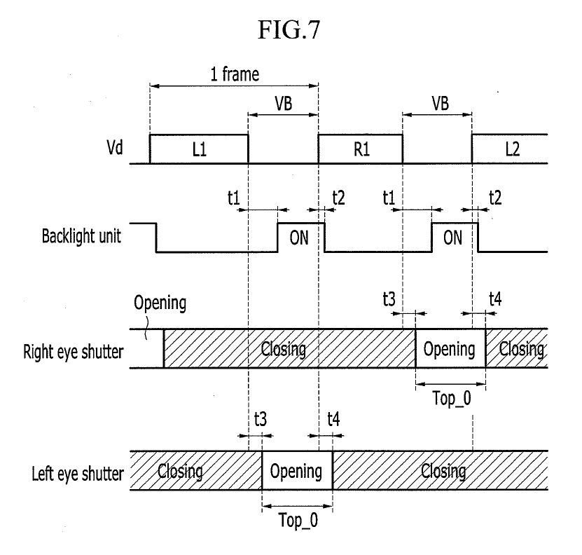

Next, a driving method of the 3D image display device will be described with reference to FIGS. 7 to 12 along with the above-described drawings.

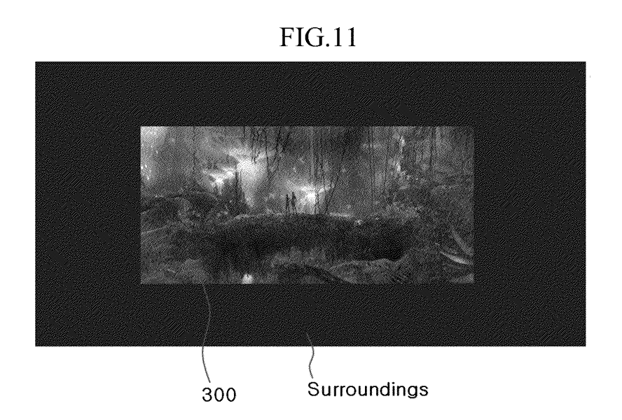

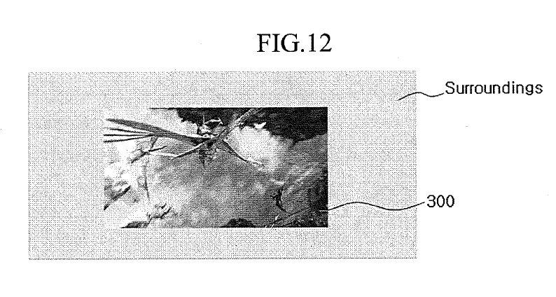

FIGS. 7 to 10 are waveform diagrams of a driving method of a 3D image display device according to an exemplary embodiment of the present invention, and FIGS. 11 and 12 are examples of an actual image and its surroundings seen through a shutter member of a 3D image display device according to an exemplary embodiment of the present invention.

Referring to FIGS. 1, and 7 to 10, if the gate driver 400 sequentially applies the gate-on voltage Von to the gate lines GL1-GLn and the data driver 500 applies the data voltage Vd to the data lines DL1-DLm, the corresponding data voltage Vd is applied to the pixel PX of the display panel 300, thereby displaying the image of the corresponding gray. The right eye data voltage R1 and the left eye data voltages L1 and L2 included in the data voltage Vd may be alternately input one per frame.

A vertical blank period VB is disposed between the input period of the right eye data voltage R1 and the input period of the left eye data voltages L1 and L2, and the data voltage Vd is not input in the vertical blank period VB. The vertical blank period VB may exist once per frame.

One of the left eye shutter and the right eye shutter of the shutter member 60 may be in the closed state and the other may be in the opened state during at least a portion of the time of the vertical blank period VB. In addition, the backlight unit 900 may emit light during at least a portion of the vertical blank period VB according to the backlight control signal CONT4 from the backlight controller 950. For example, if the left eye data voltages L1 and L2 are both input to the display panel 300, the right eye shutter is in the closed state during the vertical blank periods VB immediately following the input of the left eye data voltages L1 and L2 and the left eye shutter is in the opened state for most or all of the vertical blank periods VB immediately following the input of the left eye data voltages L1 and L2. The backlight unit 900 emits light during at least a portion of the vertical blank periods VB immediately following the input of the left eye data voltages L1 and L2 such that the left eye image displayed on the display panel 300 is shown through the left eye shutter. If the right eye data voltage R1 is input to the display panel 300, the left eye shutter is in the closed state during the vertical blank period VB immediately following the input of the right eye data voltage R1, and the right eye shutter is in the opened state for most or all of the vertical blank period VB immediately following the input of the right eye data voltage R1. The backlight unit 900 emits light during at least a portion of the vertical blank period VB immediately following the input of the right eye data voltage R1 such that the right eye image displayed on the display panel 300 is shown through the right eye shutter.

The backlight unit 900 may be turned on after a predetermined first time t1, where the first time t1 begins from a time when the input of the left eye data voltages L1 and L2 or the right eye data voltage R1 is completed and ends when the backlight unit 900 is turned on in the vertical blank VB period. The first time t1 may be a time in which the left eye shutter or the right eye shutter has been closed long enough. In other words, when the shutter that is supposed to be in the closed state in the vertical blank period VB starts to be closed at the start point of the corresponding vertical blank period VB, the backlight unit 900 does not emit light until after that shutter is completely closed such that crosstalk in which the left eye image and the right eye image appear to be overlapped may be prevented. The first time t1 may be controlled automatically or manually according to the response speed of the shutter member 60, or may be 0 seconds. For example, when the shutter that is supposed to be in the closed state in the vertical blank period VB is already closed before the start point of the corresponding vertical blank period VB, the first time t1 may be 0 seconds.

In addition, the backlight unit 900 may maintain the light emission state during a second time t2, where the second time t2 begins when the corresponding vertical blank period VB has passed and when either of the left eye data voltages L1 and L2 or the right eye data voltage R1 has started to be input to the display panel 300 and ends sometime shortly thereafter while the corresponding data voltage is still being input. For example, like a liquid crystal display, although the data voltage Vd is input to the display panel 300, when the corresponding image is displayed on the display panel 300 late due to the response speed of the liquid crystal molecules, even if the backlight unit 900 continues to emit light during the second time t2, crosstalk may not appear. The second time t2 may be controlled according to the display response speed of the display panel 300, and may be 0 seconds.

In an entire period, which may include the period when the left eye data voltages L1 and L2 or the right eye data voltage R1 is input as well as the subsequent vertical blank period VB, the opened or closed state (and consequently the opening or closing time) of the left eye shutter and the right eye shutter of the shutter member 60 may be changed according to the shutter member control signal CONT5 or, more specifically, the shutter timing information TIM, which is used to generate the shutter member control signal CONT5. This will be described with reference to FIGS. 7 to 10.

FIG. 7 exemplary shows an opened or closed state of a right eye shutter and a left eye shutter when a sum of the grays of all pixels PX, in other words, a sum of the image luminances, corresponds to the 0th step in the lookup table shown in FIG. 5, in other words, when the shutter timing information TIM is 0%. In this case, the right eye shutter may be in the opened state during at least a portion of the vertical blank period VB after the right eye data voltage R1 is input, and the left eye shutter may be in the opened state during at least a portion of the vertical blank period VB after the left eye data voltages L1 and L2 are input.

The right eye shutter and the left eye shutter may be opened if the vertical blank period VB is started and a third time t3 has passed, and may be opened before the backlight unit 900 is turned on in the corresponding vertical blank period VB or simultaneously with the turning on of the backlight unit 900. In addition, the right eye shutter and the left eye shutter may be closed after a fourth time t4 has passed after the backlight unit 900 is turned off after the corresponding vertical blank period VB. At least one of the third time t3 and the fourth time t4 may be 0 seconds. Different from that shown in FIG. 7, the right eye shutter and the left eye shutter may be closed before the vertical blank period VB has started and the backlight unit 900 is turned off.

A time that the right eye shutter or the left eye shutter is opened corresponding to one vertical blank period VB in the 0th step is referred to as a reference opening time Top_0. In this case, the value of the shutter timing information TIM may be 0%.

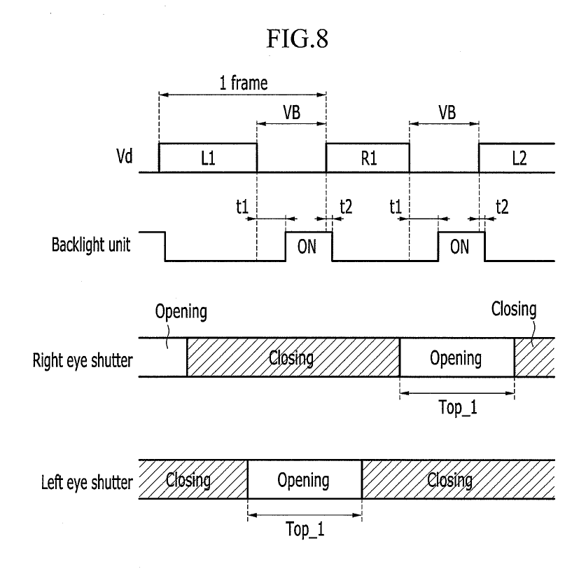

Next, FIG. 8 exemplary shows the opened or closed state of the right eye shutter and the left eye shutter when the sum of the grays of all pixels PX (or the sum of the image luminances) corresponds to the first step of the lookup table shown in FIG. 5, in other words, when the shutter timing information TIM is 10%. In this case, the right eye shutter and the left eye shutter are in the opened state during a first opening time Top_1 longer than the reference opening time Top_0 corresponding to one vertical blank period VB. In this case, the period when the left eye shutter and the right eye shutter are opened may include the period corresponding to the reference opening time Top_0 when the left eye shutter and the right eye shutter are opened in the 0th step. In other words, the first opening time Top_1 may include the reference opening time Top_0.

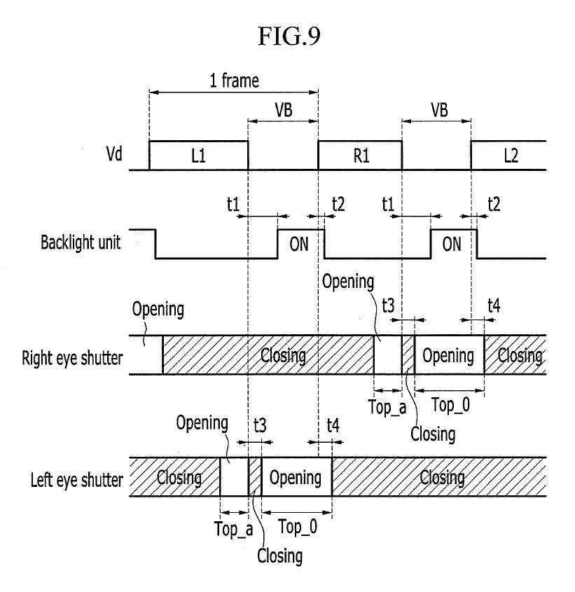

Next, FIG. 9 exemplary shows the opened or closed state of the right eye shutter and the left eye shutter when the sum of the image luminances corresponds to the first step of the lookup table shown in FIG. 5 like in FIG. 8, in other words, when the shutter timing information TIM is 10%. However, in the exemplary embodiment shown in FIG. 9, the period when the left eye shutter and the right eye shutter corresponding to one vertical blank period VB are opened may include at least two periods. In other words, the first opening time Top_1 of the left eye shutter and the right eye shutter corresponding to the first step of the lookup table shown in FIG. 5 includes the reference opening time Top_0 and an additional opening time Top_a. The reference opening time Top_0 and the additional opening time Top_a forming the first opening time Top_1 may be separated by a predetermined time, such as the third time in which the shutter briefly closes, and the additional opening time Top_a may be positioned before or after the reference opening time Top_0. The additional opening time Top_a may be positioned before the corresponding vertical blank period VB or after the corresponding vertical blank period VB. The length of the additional opening time Top_a may differ and be determined according to various settings, such as the number of steps of the sum of the image luminances of the lookup table shown in FIG. 5.

In the exemplary embodiment shown in FIG. 9, the first opening time Top_1 is divided into two periods, however the present invention is not limited thereto, and the additional opening time Top_a may be divided into a plurality of periods.

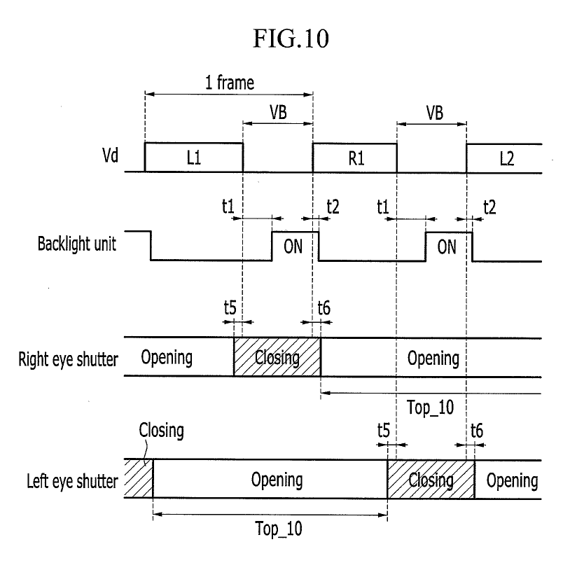

Next, FIG. 10 exemplary shows the opened or closed state of the right eye shutter and the left eye shutter when the sum of the grays of all pixels PX corresponds to the tenth step which is the final step in the lookup table shown in FIG. 5, in other words, the shutter timing information TIM is 100%. The right eye shutter and the left eye shutter may be in the opened state corresponding to one vertical blank period VB during the tenth opening time Top_10. The tenth opening time Top_10 is the longest among the opening times for all steps. For example, the tenth opening time Top_10 may be a time of the reference opening time Top_0 shown in FIG. 7 with the additional opening time Top_a shown in FIG. 9 added thereto ten times. The tenth opening time Top_10 may be divided into a plurality of periods that are separated like the first opening time Top_1 according to the exemplary embodiment shown in FIG. 9.

As shown in FIG. 10, the point when the tenth opening time Top_10 is finished may be just before or at the start point of the next vertical blank period VB as shown by a fifth time t5, and the start point of the tenth opening time Top_10 may be at the finish of a previous vertical blank period VB or shortly thereafter as shown by a sixth time t6. At least one of the fifth time t5 and the sixth time t6 may be 0 seconds.

As described above, according to the exemplary embodiments shown in FIGS. 5 and 7 to 10, when the sum of the grays of all pixels PX of the input image signal IDAT is divided into the n steps, the shutter timing information TIM may have a value that is proportional according to the divided steps. The left eye shutter or the right eye shutter of the shutter member 60 may have a shutter opening time that is increased as the shutter timing information TIM for one vertical blank period VB for one frame is increased. At this time, the opening time for one frame of the left eye shutter or the right eye shutter of the shutter member 60 may be proportional to the value of the shutter timing information TIM.

As shown in FIG. 9, the shutter opening time may be divided in a plurality of periods. The opening time (e.g., the n opening time) of the shutter according to the shutter timing information TIM corresponding to the n-th step may be longer than the shutter opening time (e.g., the n-1 opening time) according to the shutter timing information TIM corresponding to the (n-1)-th step. The period corresponding to the n opening time may include the period corresponding to the reference opening time Top_0, and the direction that the n opening time is expanded with respect to the reference opening time Top_0 and the length thereof may be freely determined. In addition, the difference between the shutter opening times of adjacent steps is referred to as an additional opening time, and the additional opening time may be constant through all steps.

When n is infinite, the shutter timing information TIM may have a value that is proportional to the sum of the grays of all pixels PX, and the shutter opening time when the shutter of the shutter member 60 is opened for one vertical blank period VB may be proportional to the value of the shutter timing information TIM.

As described above, the opened time of the shutter of the shutter member 60 is controlled according to the sum of the grays of all pixels PX of the display panel 300. In this way, by using the sum of the luminances of the image displayed by the display panel 300, the surrounding luminance of the display panel 300 seen when viewing the display panel 300 through the shutter member 60 may be changed, thereby providing a realistic 3D image.

Referring to FIG. 11, when the image displayed on the display panel 300 has a dark luminance, such as an image of a cave or night, the shutter timing information TIM has a small value in proportion to the luminance of the image, and the time that the shutter of the shutter member 60 is opened is controlled to be short in proportion to the shutter timing information TIM. Accordingly, the opened time of the shutter may be controlled to have the reference opening time Top_0 or a similarly short time, and thus, the surrounding luminance of the display panel 300 seen through the shutter member 60 may be barely recognized. Thus, the perception that the user of the 3D image display device is actually in a cave or the feeling that it is actually night may be enhanced such that the realism of the 3D image may be increased.

Referring to FIG. 12, when the image displayed on the display panel 300 has a bright luminance, such as a daytime image, the shutter timing information TIM has a high value in proportion to the luminance of the image, and the time that the shutter of the shutter member 60 is opened is controlled to be long in proportion to the shutter timing information TIM. For example, the opened time of the shutter may be controlled to have the tenth opening time Top_10. Thus, the surrounding luminance of the display panel 300 seen through the shutter member 60 may be high. Accordingly, the user of the 3D image display device may have a feeling that they are actually in a bright place.

As described above, when the luminance of the image displayed on the display panel 300 is high, the surrounding luminance of the display panel 300 seen through the shutter member 60 is high, and when the luminance of the image displayed on the display panel 300 is low, the surrounding luminance of the display panel 300 seen through the shutter member 60 is low, such that the display effect of the 3D image may be increased and the realism of the 3D image may be increased.

In an exemplary embodiment of the present invention, the backlight unit 900 mainly emits light during at least a portion of the time of the vertical blank period VB and is turned off during most of the time that the data voltage Vd is input such that power consumption may be reduced.

In the above-described exemplary embodiments, the grays for all pixels PX of the input image signal IDAT are summed in the shutter timing determining unit 710 to generate the shutter timing information TIM. In other words, the open and close timing of the shutter of the shutter member 60 is controlled based on the sum of the grays of all pixels. However, the present invention is not limited thereto. For example, the open and close timing of the shutter of the shutter member 60 may be controlled based on the sum of the grays of some pixels PX. Here, the some pixels PX may be a plurality of pixels PX positioned at the center of the display panel 300.

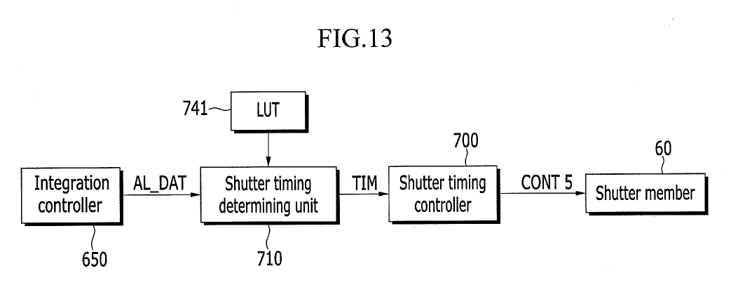

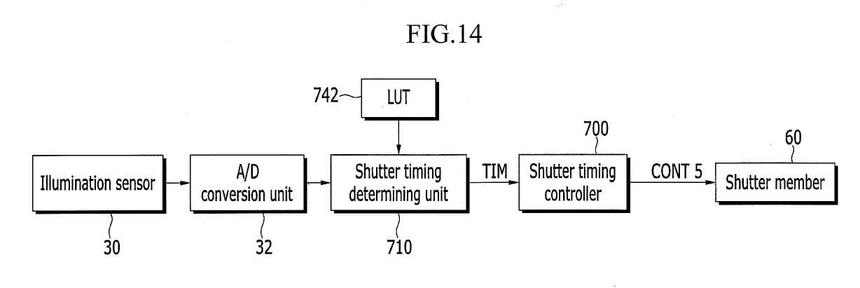

Next, 3D image display devices according to exemplary embodiments of the present invention will be described with reference to FIGS. 13 and 14, respectively. For reference numerals of the aforementioned figures that designate like elements in FIGS. 13 and 14, the same descriptions will be omitted.

FIGS. 13 and 14 are block diagrams of controllers for controlling shutter members of a 3D image display device according to exemplary embodiments of the present invention.

According to an exemplary embodiment shown in FIG. 13, the shutter timing determining unit 710 receives a surrounding luminance control signal AL_DAT from the integration controller 650 to generate shutter timing information TIM. The surrounding luminance control signal AL_DAT as the information for the surrounding luminance of the display panel 300 may be selected by an image producer or a user, and may be selected regardless of the gray of the input image signal IDAT. In other words, the surrounding luminance control signal AL_DAT may be the information for the surrounding luminance that is changed according to the image that is changed according to the input image signal IDAT or the intention of the image producer. The surrounding luminance control signal AL_DAT may be allotted while having an additional bit for the input image signal IDAT for every frame, or may be a separate signal that is synchronized with each frame of the input image signal IDAT.

The shutter timing determining unit 710 may select the image luminance step corresponding to the surrounding luminance control signal AL_DAT, and the corresponding shutter timing information TIM, and may output the shutter timing information TIM to the shutter timing controller 700. For example, the shutter timing determining unit 710 may select the shutter timing information TIM by using the lookup table 741, and may calculate the shutter timing information TIM by using the linear functional equation. The lookup table 741 may be positioned inside the shutter timing determining unit 710 or outside the shutter timing determining unit 710.

According to the exemplary embodiment shown in FIG. 13, the user of the 3D image display device as well as the image producer may directly control the surrounding brightness of the display panel 300 through the surrounding luminance control signal AL_DAT, thereby enabling the 3D image to be adjusted according to the user's preference, or to the image producer's optimized settings.

The 3D image display device according to the exemplary embodiment shown in FIG. 14 further includes an illumination sensor 30 and an analog-to-digital (A/D) conversion unit 32 that converts the analog signal from the illumination sensor 30 into a digital signal. The illumination sensor 30 positioned at the integration controller 650 senses the surrounding luminance to generate a detection signal based on the sensing and outputs the detection signal to the A/D conversion unit 32. The A/D conversion unit 32 A/D-converts the detection signal for the surrounding luminance to generate the surrounding luminance information as a digital signal and outputs the digital signal to the shutter timing determining unit 710. The shutter timing determining unit 710 receives the surrounding luminance information to generate the shutter timing information TIM. At this time, the shutter timing determining unit 710 may select the shutter timing information TIM corresponding to the surrounding luminance information in the lookup table 742 and may calculate the shutter timing information TIM by using a functional equation having the surrounding luminance information as a variable. The lookup table 742 may be positioned inside the shutter timing determining unit 710 or outside the shutter timing determining unit 710.

According to the exemplary embodiment shown in FIG. 14, the open and close timing of the shutter of the shutter member 60 is actively controlled according to the surrounding luminance of the display panel 300 of the 3D image display device such that the impact of the surrounding luminance seen through the shutter member 60 may be controlled. For example, when the surrounding luminance is very high, the surrounding luminance seen through the shutter member 60 may be controlled by reducing the opened time of the shutter of the shutter member 60.

According to the above-described exemplary embodiments, in the 3D image display device including the shutter member, the time that the shutter of the shutter member is opened is actively controlled to control the luminance of the area surrounding a displayed image such that the 3D display effect and realism of the image may be enhanced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A three-dimensional (3D) image display device, comprising:
a display panel assembly including a display panel displaying an image and a timing controller;
an integration controller transmitting an input image signal to the timing controller;
a shutter member including a left eye shutter and a right eye shutter;
a shutter timing determining unit receiving a shutter member control source signal from the integration controller or an outside source to generate shutter timing information; and
a shutter timing controller receiving the shutter timing information to generate a shutter member control signal and transmitting the shutter member control signal to the shutter member,
wherein an open time or a close time of the left eye shutter or the right eye shutter for a frame is based on the shutter timing information.

2. The 3D image display device of claim 1, wherein the open time of the left eye shutter or the right eye shutter for the frame increases as a value of the shutter timing information increases.

3. The 3D image display device of claim 2, wherein the display panel assembly further includes a data driver transmitting a data voltage to a data line of the display panel, the data voltage includes a left eye data voltage and a right eye data voltage, a vertical blank period is positioned between an input period of the left eye data voltage and an input period of the right eye data voltage, and
at least a portion of the open time of the left eye shutter or the right eye shutter for the frame is positioned in the vertical blank period.

4. The 3D image display device of claim 3, wherein
only one of the left eye shutter and the right eye shutter is opened in the vertical blank period.

5. The 3D image display device of claim 4, further comprising:
a backlight unit providing light to the display panel,
wherein the backlight unit provides the light after a first time has elapsed until a second time elapses, wherein the first time is measured from an end point of the input period of the data voltage prior to the vertical blank period, and the second time is measured from a starting point of the input period of the data voltage after the vertical blank period.

6. The 3D image display device of claim 5, wherein at least one of the first time and the second time is 0.

7. The 3D image display device of claim 1, wherein the shutter member control source signal includes the input image signal, and
the shutter timing determining unit includes an image luminance summing unit receiving the input image signal from the integration controller or the timing controller and summing grays for a plurality of pixels from the input image signal to calculate a sum value.

8. The 3D image display device of claim 7, wherein the shutter timing determining unit includes:
a lookup table storing image luminance steps having corresponding sum values and corresponding shutter timing information values; and
a step pointing unit selecting an image luminance step and the shutter timing information corresponding to the sum value from the lookup table.

9. The 3D image display device of claim 7, wherein the shutter timing determining unit includes a shutter timing calculation unit calculating the shutter timing information based on the sum value.

10. The 3D image display device of claim 9, wherein the shutter timing calculation unit calculates the shutter timing information according to a linear function equation.

11. The 3D image display device of claim 10, wherein the display panel assembly further includes a data driver transmitting a data voltage to a data line of the display panel,
the data voltage includes a left eye data voltage and a right eye data voltage;
a vertical blank period is positioned between an input period of the left eye data voltage and an input period of the right eye data voltage, and
at least a portion of the open time of the left eye shutter or the right eye shutter for the frame is positioned in the vertical blank period.

12. The 3D image display device of claim 11, wherein when the sum value is the highest value in the lookup table, the open time of the right eye shutter or the left eye shutter for the frame starts when a third time has elapsed from a start point of the input period of the data voltage prior to the vertical blank period, and ends a fourth time prior to an end point of the input period of the data voltage after the vertical blank period.

13. The 3D image display device of claim 12, wherein at least one of the third time and the fourth time is 0.

14. The 3D image display device of claim 1, wherein the shutter member control source signal includes a surrounding luminance control signal, and the shutter timing determining unit generates the shutter timing information according to the surrounding luminance control signal input from the integration controller.

15. The 3D image display device of claim 1, further comprising:
an illumination sensor sensing surrounding luminance to generate a detection signal; and
an analog-to-digital (A/D) conversion unit A/D-converting the detection signal to generate surrounding luminance information,
wherein the shutter member control source signal includes the surrounding luminance information, and
the shutter timing determining unit receives the surrounding luminance information to generate the shutter timing information.

16. A method for driving a three-dimensional (3D) image display device including a display panel assembly including a display panel and a timing controller, an integration controller transmitting an input image signal to the timing controller, a shutter member including a left eye shutter and a right eye shutter, and a shutter timing determining unit, the method comprising:
receiving, at the shutter timing determining unit, a shutter member control source signal from the integration controller or an outside source to generate shutter timing information; and
controlling, with a shutter timing controller of the 3D image display device, an open time or a close time of the left eye shutter or the right eye shutter for a frame according to the shutter timing information.

17. The method of claim 16, wherein the open time of the left eye shutter or the right eye shutter for the frame is increased as a value of the shutter timing information is increased.

18. The method of claim 17, wherein the shutter member control source signal includes the input image signal from the integration controller or the timing controller, and
the method further comprises:
inputting the input image signal to the shutter timing determining unit; and
summing, at the shutter timing determining unit, grays for a plurality of pixels from the input image signal to calculate a sum value.

19. The method of claim 17, wherein the shutter member control source signal includes a surrounding luminance control signal, and
the method further comprises inputting the surrounding luminance control signal to the shutter timing determining unit.

20. The method of claim 17, further comprising:
sensing, with an illumination sensor of the 3D image display device, a surrounding luminance to generate a detection signal;
using an analog-to-digital (A/D) converter of the 3D image display device to A/D-convert the detection signal to generate surrounding luminance information; and
inputting, from the A/D converter, the surrounding luminance information as the shutter member control source signal to the shutter timing determining unit.

21. A three-dimensional (3D) image display device, comprising:
a display panel displaying an image;
a shutter member including a first shutter and a second shutter; and
a shutter timing determining unit generating shutter timing information based on a luminance of an area surrounding the image,
wherein an open time of the first or second shutter is controlled in accordance with the shutter timing information.
